(19) United States
(12) Patent Application Publication
(10) Pub. No.: US 2009/0265382 A1
(43) Pub. Date: Oct. 22, 2009

(54) METHOD AND APPARATUS FOR SENDING MESSAGES ON BEHALF OF DEAD PERSONS TO LIVE RECIPIENTS

(75) Inventors: Daniel J. Freiman, Philadelphia, PA (US); Mark A. Weiss, Rydal, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: ColorQuick, L.L.C., Pennsauken, NJ (US)

(21) Appl. No.: 12/104,910

(22) Filed: Apr. 17, 2008

(51) Int. Cl. G06F 15/16; G06F 17/30

(52) U.S. Cl. 707/104.1; 709/206; 707/E17.009

(57) ABSTRACT

Messages are automatically sent on behalf of dead persons to live recipients. An administration computer receives and stores message information from a plurality of live customers. The message information for each customer includes identity data of the customer, identity data of one or more recipients who are to receive one or more messages from the customer after the customer dies, message data to be sent to the one or more recipients, wherein the message data is the one or more messages, and message sending instructions including timing information regarding when to send the one or more messages after the customer dies. A life/death customer status file is maintained in the administration computer regarding the plurality of customers who previously stored message information in the administration computer. The life/death customer status file is periodically updated by comparing its entries to a current decedent file. The one or more messages previously stored by a customer are sent to the one or more recipients in accordance with the stored message sending instructions when a customer is determined as having died as a result of the comparison.

### BACKGROUND OF THE INVENTION

Many living persons would like to communicate messages to certain individuals, but for a variety of reasons, cannot or do not wish to do so during their life. Other persons who send messages during their life would like to continue to send such messages after their death. A person's will may be written to include instructions to convey certain types of messages to individuals during the probate process, but a will is not a widely or publicly circulated document and has limited flexibility for such a purpose.

Software agents exist for allowing individuals to electronically delegate tasks to be performed at a future date. U.S. Pat. No. 5,983,200 (Slotznick) describes one such software agent. However, the tasks are initiated when a pre-programmed date occurs, not as a result of a condition occurring with respect to the customer who orders the tasks, such as the death of the customer.

### BRIEF SUMMARY OF THE INVENTION

Messages are automatically sent on behalf of dead persons to live recipients. An administration computer receives and stores message information from a plurality of live customers. The message information for each customer includes identity data of the customer, identity data of one or more recipients who are to receive one or more messages from the customer after the customer dies, message data to be sent to the one or more recipients, wherein the message data is the one or more messages, and message sending instructions including timing information regarding when to send the one or more messages after the customer dies. A life/death customer status file is maintained in the administration computer regarding the plurality of customers who previously stored message information in the administration computer. The life/death customer status file is periodically updated by comparing its entries to a current decedent file. The one or more messages previously stored by a customer are sent to the one or more recipients in accordance with the stored message sending instructions when a customer is determined as having died as a result of the comparison.

A similar process is also provided for automatically sending gifts on behalf of dead persons to live recipients.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a flowchart of the process for registering a new customer and setting up a message in accordance with one preferred embodiment of the present invention.

FIG. 2 is a flowchart of the process for updating stored information based on a decedent file in accordance with one preferred embodiment of the present invention.

FIG. 3 is a schematic block diagram of a hardware configuration in accordance with one preferred embodiment of the present invention for sending messages.

FIG. 4 is a schematic block diagram of a hardware configuration in accordance with another preferred embodiment of the present invention for sending gifts.

FIGS. 5-15 are user interface display screens in accordance with one embodiment of the present invention.

### DETAILED DESCRIPTION OF THE INVENTION

### I. Overview of Preferred Embodiments of Present Invention

An automated computer-implemented process is provided that sends messages on behalf of dead persons to live recipients. The process operates as follows:

1. Message information is received and stored in an administration computer from a plurality of live customers of a service. The customers are also referred to interchangeably as “members” or “senders.” The message information for each customer includes at least the following information:

a. Identity data of the customer.

b. Identity data of one or more recipients who are to receive one or more messages from the customer after the customer dies. The identity data of the one or more recipients includes mailing address data which may be validated in accordance with well-known industry practices.

c. Message data to be sent to the one or more recipients. The message data constitutes the one or more messages that are to be sent to recipients.

d. Message sending instructions including timing information regarding when to send the one or more messages after the customer dies. The timing information may indicate that messages are sent upon death of a customer, upon the first occurrence of a date after the death of a customer, upon the periodic occurrence of a date after the death of a customer, upon a predefined future date after the customer dies, or upon any combination of these events.

2. A life/death customer status file is maintained in the administration computer regarding the plurality of customers who previously stored message information in the administration computer.
3. The life/death customer status file is periodically updated by comparing its entries to a current decedent file.
4. The one or more messages previously stored by a customer are sent to the one or more recipients when a customer is determined as having died. The one or more messages are then sent in accordance with the stored message sending instructions. Monetary payment must be made by the customer before any messages are sent.

In addition to the life/death customer status file, a life/death recipient status file is also maintained in the administration computer. The recipients that are initially designated by a customer to receive a message are also periodically compared to the current decedent file. If a recipient who has not yet received any messages dies, then no messages are ever sent to that recipient. If the recipient has previously received one or more messages and is scheduled to receive more messages, then no further messages are sent to the recipient. Thus, only live recipients receive messages.

In one preferred embodiment, the messages are printed material and are sent by the U.S. Postal Service (USPS) or by a private mail service to the recipients. In another preferred embodiment, the messages are in electronic form and electronic messages such as emails are sent to the recipients that either include the messages or links to the messages. For example, the message may constitute audio/visual material and the recipient would receive an email with a link to the audio/visual material.

In one preferred embodiment, the customer may subsequently edit the message information after it is initially stored, such as to update the identity date of the recipients, the messages themselves, or the sending instructions.

### II. Detailed Disclosure

The present invention is described in the context of a proposed web-based commercial service wherein customers register at a website (e.g., beyondthegravepress.com or heavensentpress.com) where they can enter requested information and make payment. However, the scope of the present invention is not limited to this particular implementation of the invention. The present invention is described in the context of a plurality of customer computers and an administration computer. Each customer computer communicates with the administration computer (e.g., web site server) via an electronic network, such as a LAN or the Internet. The customer computers may be any type of computing device that allows a user to interact with a web site via a web browser. For example, the computers may be personal computers (PC) that run a Microsoft Windows® operating system. The computers may also be handheld, wireless devices.

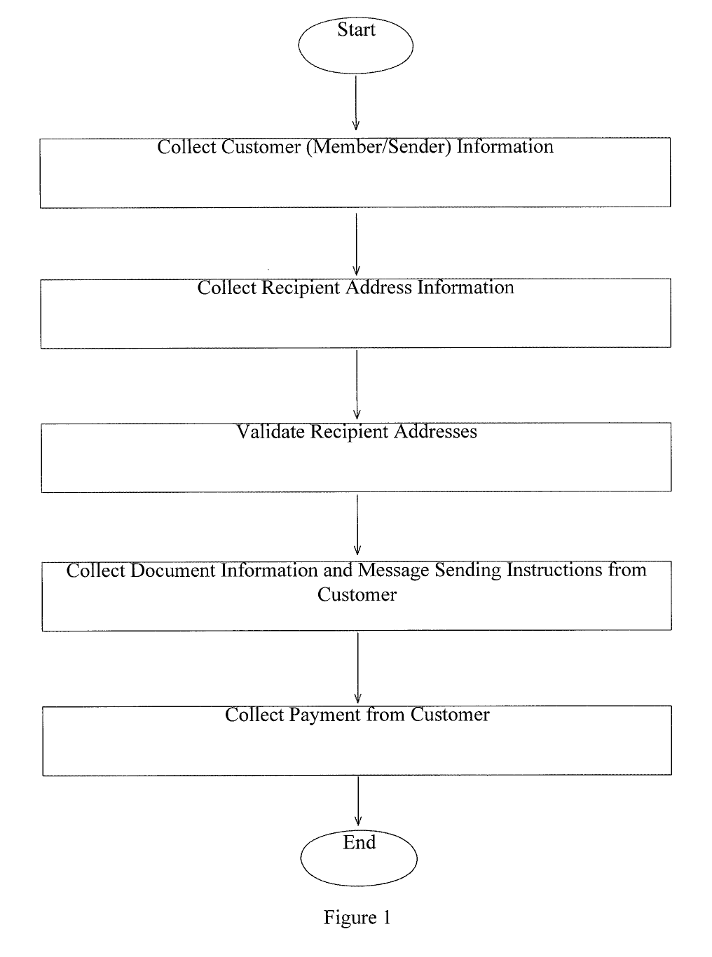

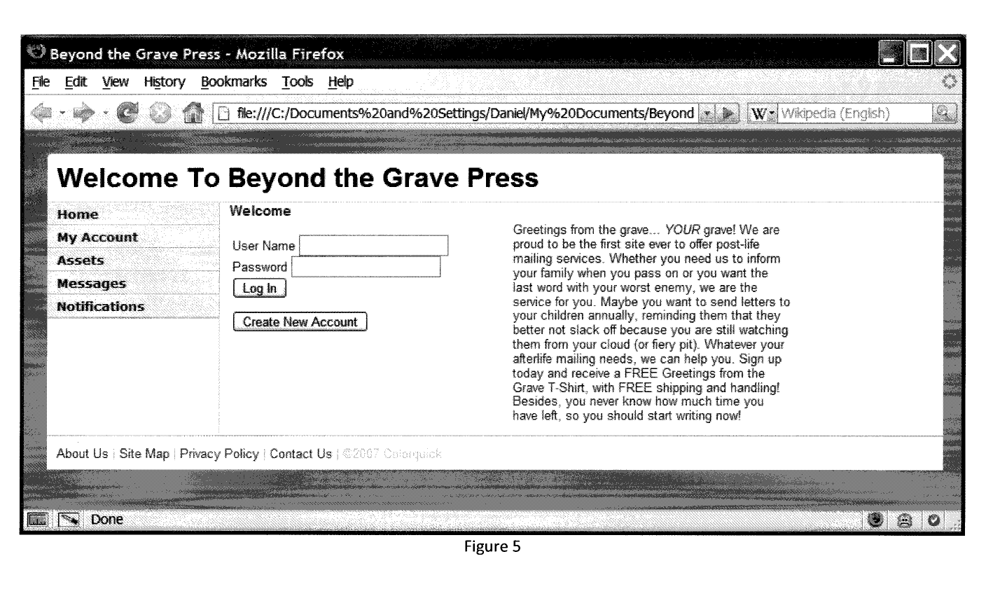

FIG. 1 is a flowchart of the process for registering a new customer in accordance with one preferred embodiment of the present invention. Assuming that the customer registers at a web site that hosts the service, the customer interacts with a plurality of user-interface display screens (shown in FIGS. 5-15) to enter the necessary information. Registration may also occur by mail wherein all of the requested information is submitted in written form and entered into the administration computer by an automated or manual transcribing process.

Customer information (identity data) includes at least the following items:

1. Unique username with optional password

2. Name and Address

3. Social Security number

4. email address

The customer information is stored in a customer information database of the administration computer.

Next, the recipient information (recipient identity data) is collected, including a full name and address. In one alternative embodiment, the customers may select “beneficiary recipients” who will automatically take the place of an initially designated recipient if the initially designated recipient dies.

Preferably, the messages are to be sent by the USPS or by a private mail service so that a list of the addresses may be validated using conventional address validation software, such as the USPS Delivery Point Validation (DPV) database. All validated addresses are then stored in a recipient list which is part of the life/death recipient status file. Similar validation occurs for the beneficiary recipients.

If the messages are to be sent by other means, such as electronically (e.g., email) or by telephone, then additional recipient information is collected, such as email addresses and telephone numbers. However, at the present time, these communication formats cannot be effectively updated since there are no reliable, national database services that can periodically update this type of recipient information. However, the scope of the present invention includes such communication forms which may be used as the exclusive message delivery mode, or in conjunction with a physical mailing.

Next, document information is collected from the customer. The document information includes one or more messages that the customer wishes to send to the recipients (also, referred to as “message data”) and message sending instructions. In one preferred embodiment, a message may be in the form of a customized letter. The letter may optionally include artwork, an audio/visual file (either accompanying the message such as on a compact disc or DVD or available via a web site link), or a gift. The message sending instructions include timing information regarding when to send the one or more messages after the customer dies, as discussed above. The timing information may indicate that messages are sent upon death of a customer, upon the first occurrence of a date after the death of a customer, upon the periodic occurrence of a date after the death of a customer, upon a predefined future date after the customer dies, or upon any combination of these events.

During or after the information collection steps, the customer is informed of the cost to pay for delivery of the one or more messages. Full payment guarantees that the messages will be delivered to all living recipients upon the death of the customer in accordance with the message sending instructions. Payment may be made by any conventional means, such as a credit card.

After completion of the process, a customer may log onto the web site using their username and password (if required) and make edits to certain information. In one preferred embodiment, some edits will not incur any additional cost, such as revising the contents of a message, updating recipient address information, or deleting recipients. Other edits may incur additional cost, such as adding additional recipients or adding certain types of document information, such as a new audio/visual file. These types of edits would cause the service to incur additional costs when fulfilling the customer's request and thus would likely require additional payment.

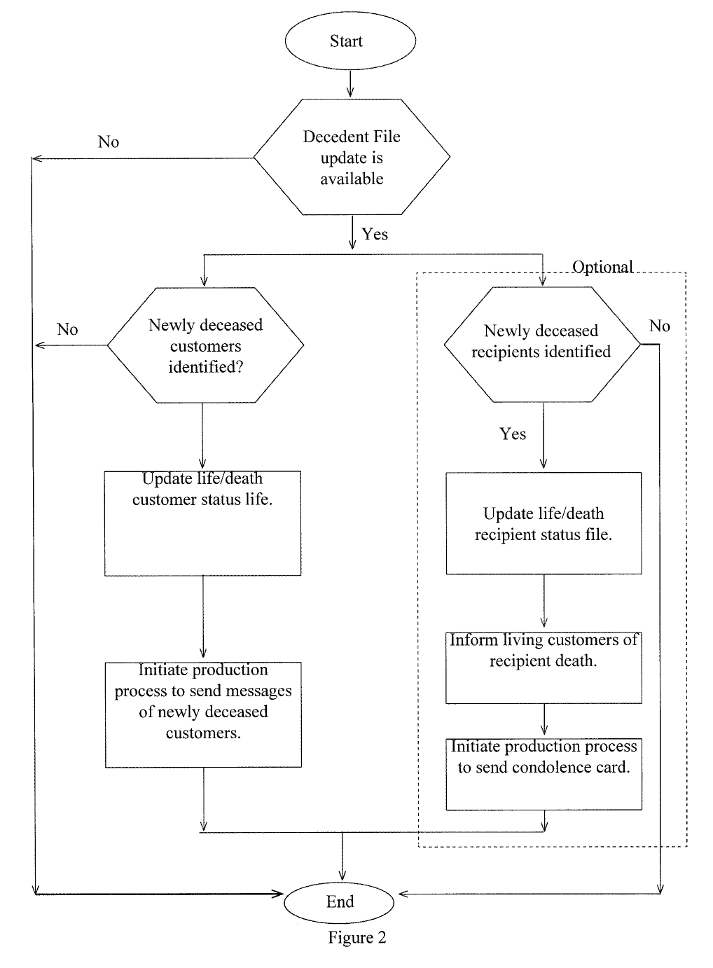

Referring to FIG. 2, the customer information in the customer information database is compared periodically, such as weekly, to a death master database or decedent file. A decedent file is a file of deceased persons. Any suitable process may be implemented to make this comparison. One such process is described in U.S. Patent Application Publication No. 2007/0156417 (Balogh) which is incorporated by reference herein. If the result of this comparison identifies any newly deceased customers, the life/death customer status file is updated and a production process is initiated to send out the customer's messages in accordance with the sending instructions and timing information. Optionally, the decedent file is also used to identify any newly deceased recipients. If any such recipients are identified, the recipient life/death customer status file is updated and the living customers associated with the newly deceased recipients may be informed of this fact either electronically or by mail. The customers may then choose to select a different recipient if the service allows for this option. For an additional fee, the customers may also choose to initiate a production process wherein a condolence card is sent out to relatives of the deceased recipient. Alternatively, such a fee may have been prepaid in which case the production process is initiated automatically.

Periodically, such as quarterly, the recipient list is updated using national change-of-address software such as NCOA^{Link} data commercially available from the USPS. Likewise, the customer information in the customer information database may also be updated using this data so that any notices that need to be mailed to living customers are properly addressed.

Recipients may be individual persons or business entities (e.g., a company, organization, government agency). If the recipient is a business entity, different types of databases than the ones discussed above may need to be accessed to perform address updating and the life/death updating.

The customer may designate a secondary account controller who is given limited access to the customer information upon the death of the customer to allow for selected changes to be made to the customer's instructions. The customer designates the type of changes that are permitted and provides appropriate contact information regarding the secondary account controller. Notification to the secondary account controller occurs automatically upon the death of the customer. If a secondary account controller is designated, the same life/death updating occurs with respect to the controller as it does with respect to customers and recipients so that customers may be notified if a secondary account controller predeceases the customer.

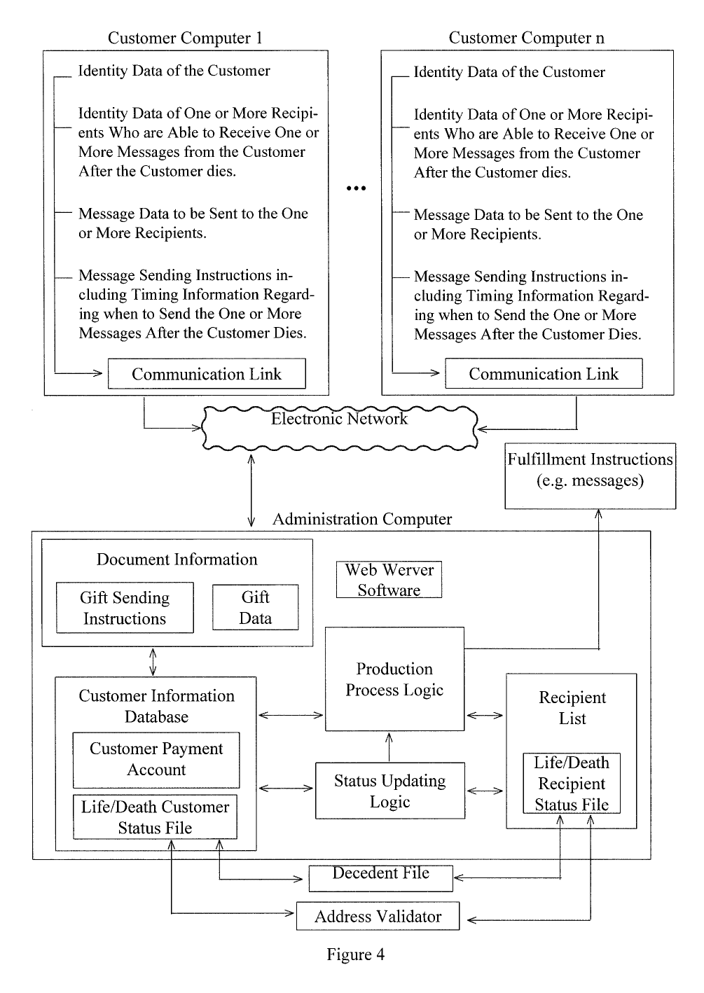

As discussed above, the message may include a gift. In an alternative embodiment, the customer designates one or more gifts (including money) to be sent to one or more recipients, with or without messages, upon the death of the customer. The system and method for implementing this process are identical to the system and method for sending messages, except that the messages are replaced by gifts. In the gift embodiment shown in FIG. 4, the customer prepays a fixed amount and receives an account that is used to pay for the gifts as they are delivered in accordance with the customer's request. Upon depletion of the account, no further gifts are sent even if the customer set up the account to send the gifts periodically. During setup of the customer account, the customer agrees to terms of service that define how the prepaid account is to be treated from a financial perspective (e.g., interest payments, if any; transferability options if recipients predecease the customer, tax treatment) and how gift requests are to be fulfilled (e.g., permissible substitutions, treatment of gift requests that for whatever reason subsequently cannot be filled). Since the gift embodiment requires purchase of a gift to fulfill the customer's request, the production process will include additional steps to facilitate the purchase. Any suitable e-commerce system may be used for these steps, such as those described in U.S. Pat. No. 5,983,200 (Slotznick), which is incorporated by reference herein.

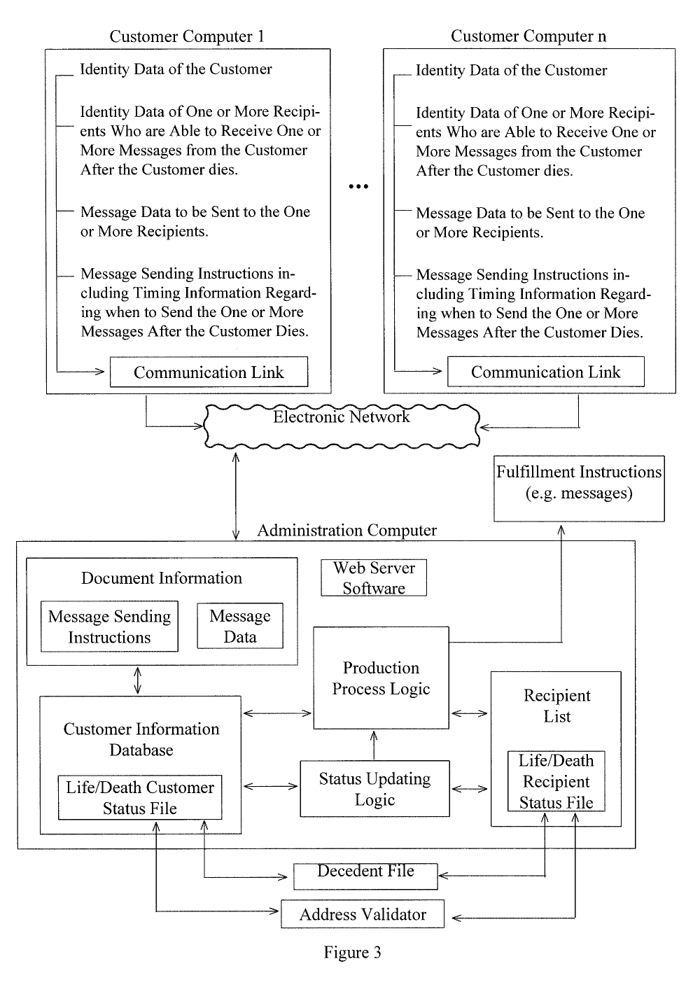

FIG. 3 shows a schematic block diagram of a system architecture/hardware configuration in accordance with one preferred embodiment of the present invention. A plurality of customer computers communicate via an electronic network with a web server associated with the administration computer. The administration computer includes the various storage and logic elements:

1. document information, including message sending information and message data

2. customer information database, including life/death customer status file

3. recipient list, including life/death recipient status file

4. web server software

5. status updating logic for implementing the steps in the FIG. 2 status updating process

6. production process logic for producing fulfillment instructions (e.g., initiating the sending of messages) associated with deceased customers.

The production process may be implemented by any suitable order fulfillment process and associated software.

FIGS. 5-15 show sample user interface display screens in accordance with one embodiment of the present invention.

FIGS. 5-15 show sample user interface display screens in accordance with one embodiment of the present invention.

FIG. 5 shows a welcome and logon screen for the website.

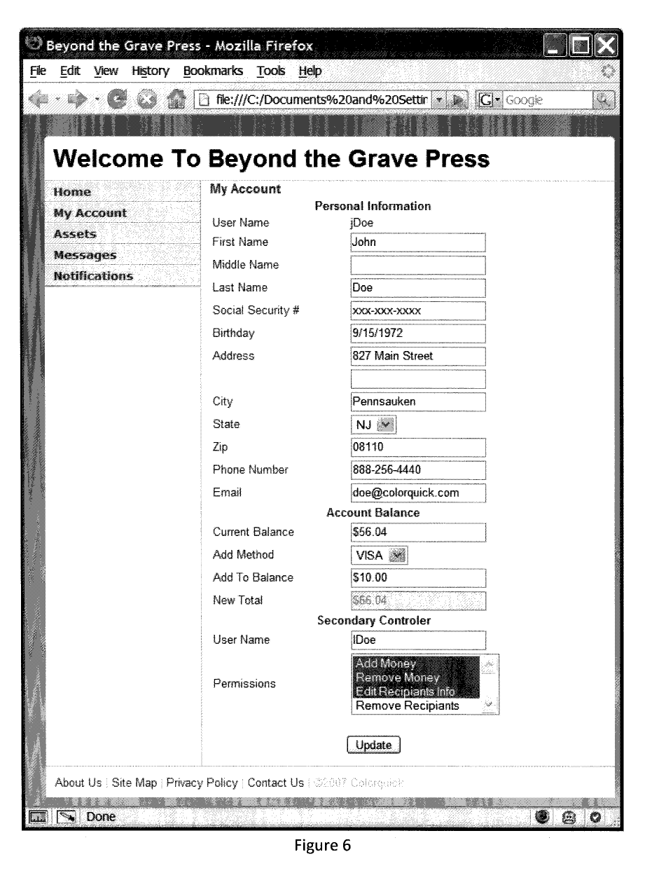

FIG. 6 shows the account information page of the website. A user may edit any information associated with his account from this page including identifying information, contact information, account balance, and a secondary controller for the account.

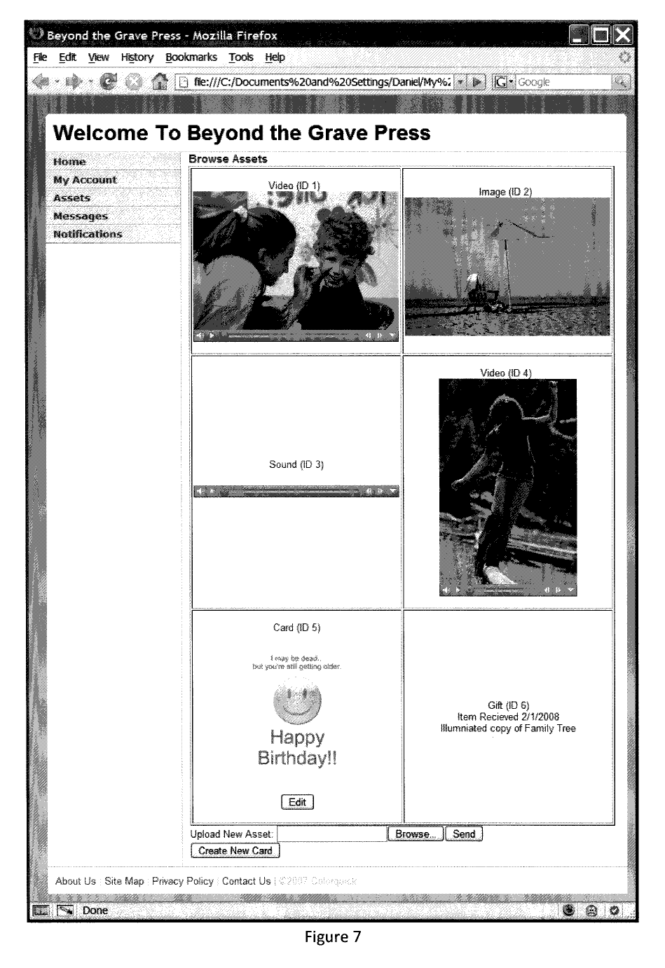

FIG. 7 shows how a user can browse his assets and allows him to create new assets. Assets shown are new cards, tangible gifts, and multimedia files.

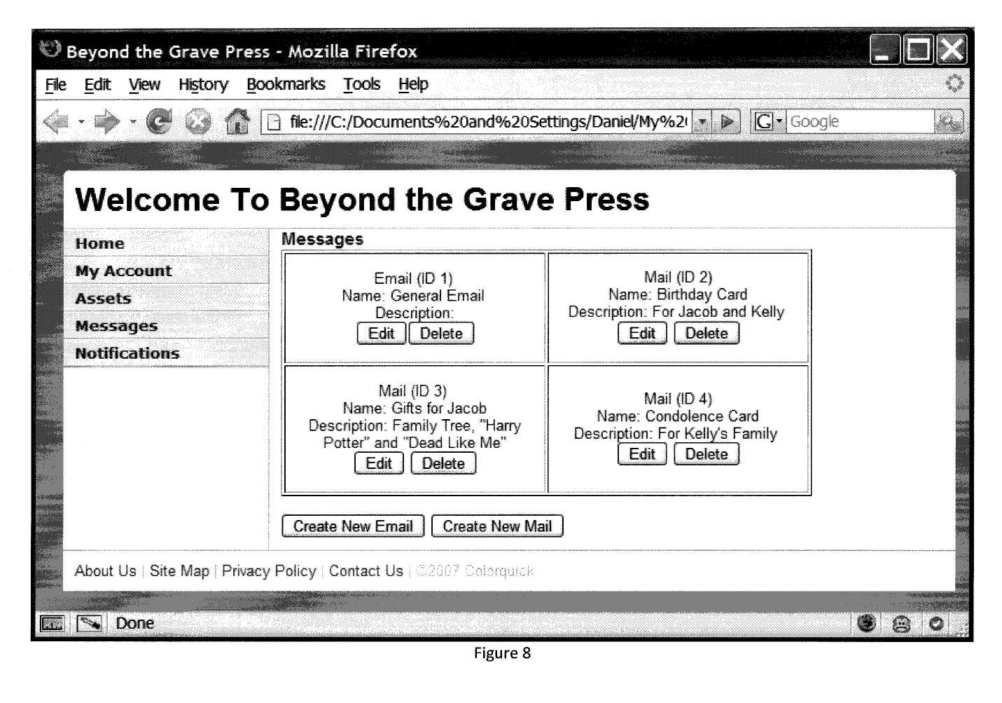

FIG. 8 shows how a user can create new messages or browse his saved messages and associated instructions by user defined name or description. Once the user locates a message of interest, they may delete or edit that message.

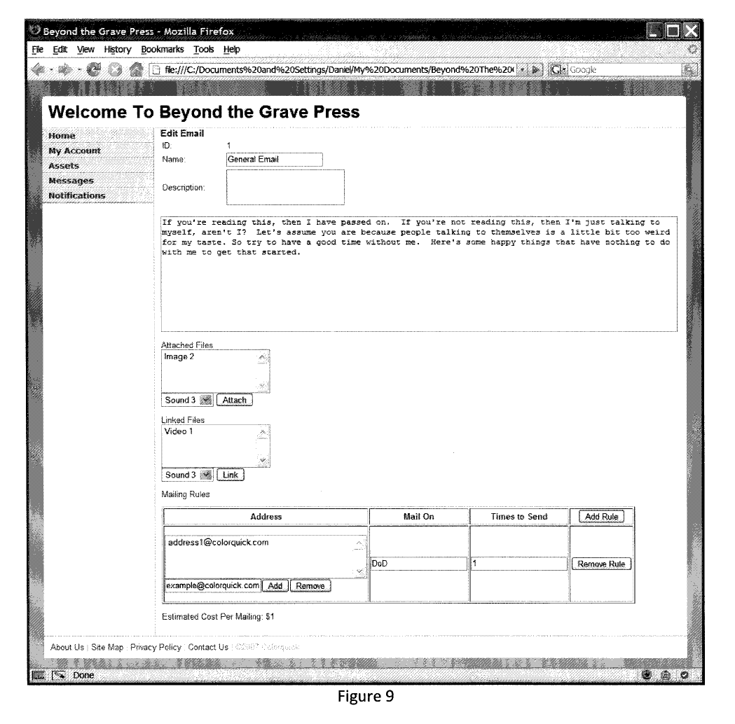

FIGS. 9-12 show varying messages and associated instructions that may be executed in accordance with this embodiment of the present invention.

FIG. 9 shows an instruction set to send an email upon the death of the customer. One image will be sent as an attached file and a link to a video file. The email will be sent to “address1@colorquick.com.” FIG. 9 also shows the user in the process of adding a second, additional, email address, “example@colorquick.com,” to send the email to upon the death of the user. The estimated cost of the emailing is also previewed.

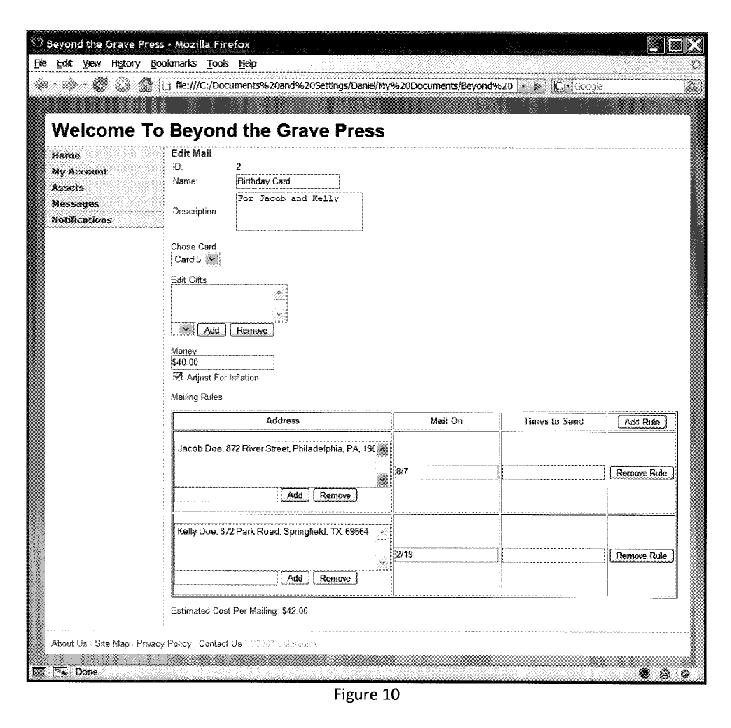

FIG. 10 shows an instruction set to send physical mail upon the death of the customer. A gift card has been selected to be sent in this package, along with $40. The $40 will be adjusted for inflation starting at the time of the user's death. The customer has set up 2 periodic mailings for this card and money package, to be mailed yearly on August 7^{th} to Jacob Doe, and on February 19^{th} to Kelly Doe, until the customer's account is empty.

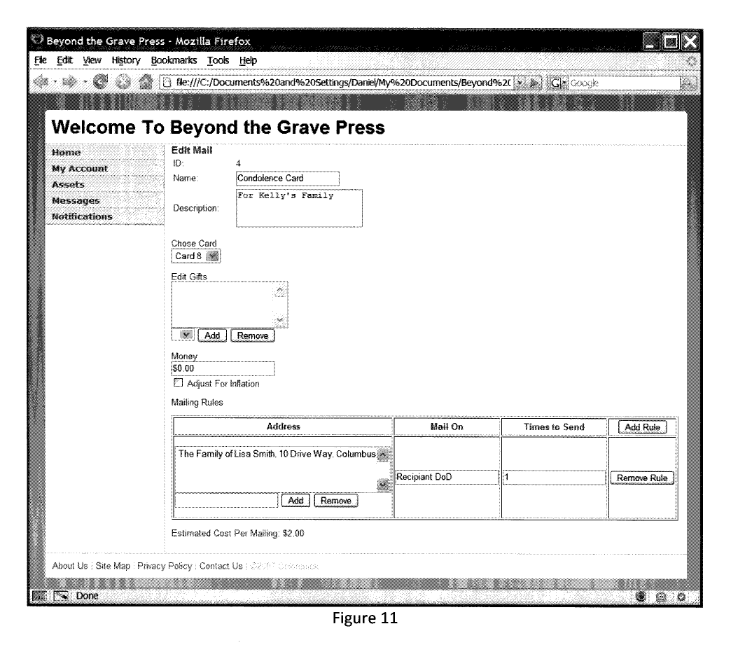

FIG. 11 shows an instruction set to send a card upon the death of the recipient of the mailing.

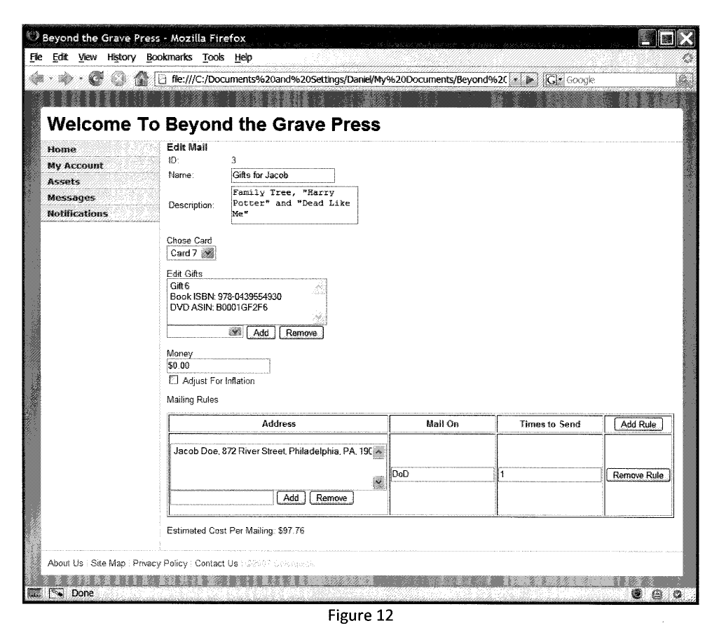

FIG. 12 shows an instruction set to send physical mail upon the death of the customer. The recipient will receive a card, a book, a dvd, and a gift sent to and warehoused by beyondthegravepress.com.

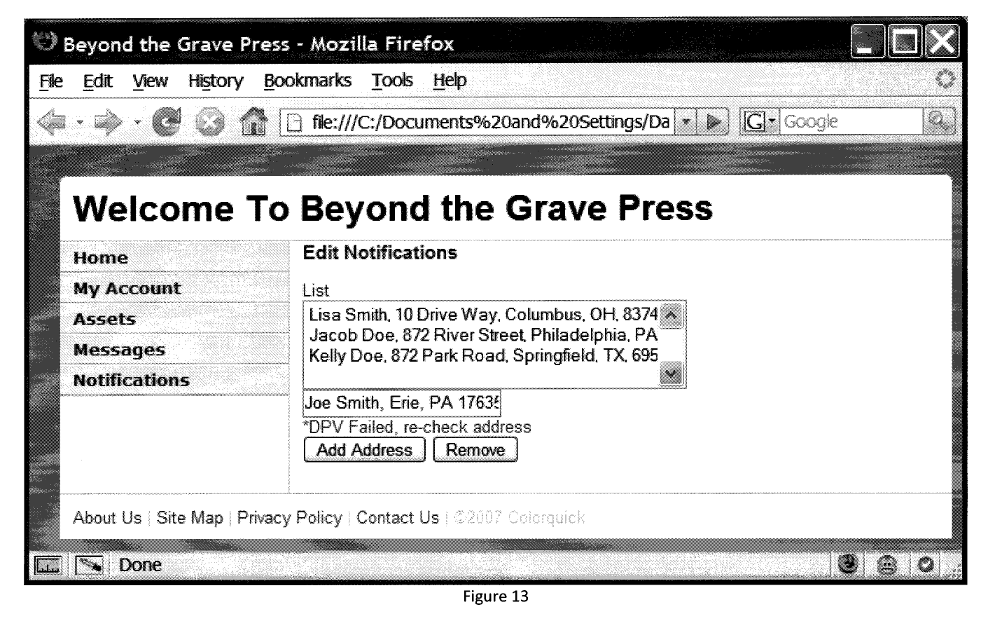

FIG. 13 shows the user entering information for individuals. The user will be notified of these individuals' deaths. It is also shown how an address can be validated for correctness and could be rejected by the system if found invalid. This validation could occur anywhere an address is entered into the system by a user.

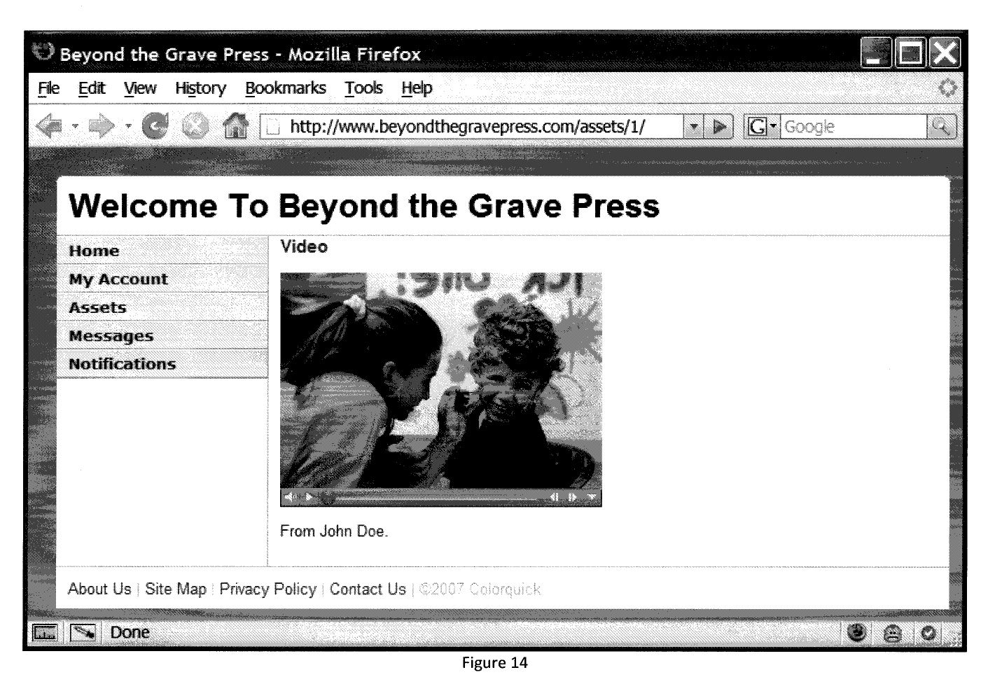

FIG. 14 shows the landing page for a linked asset.

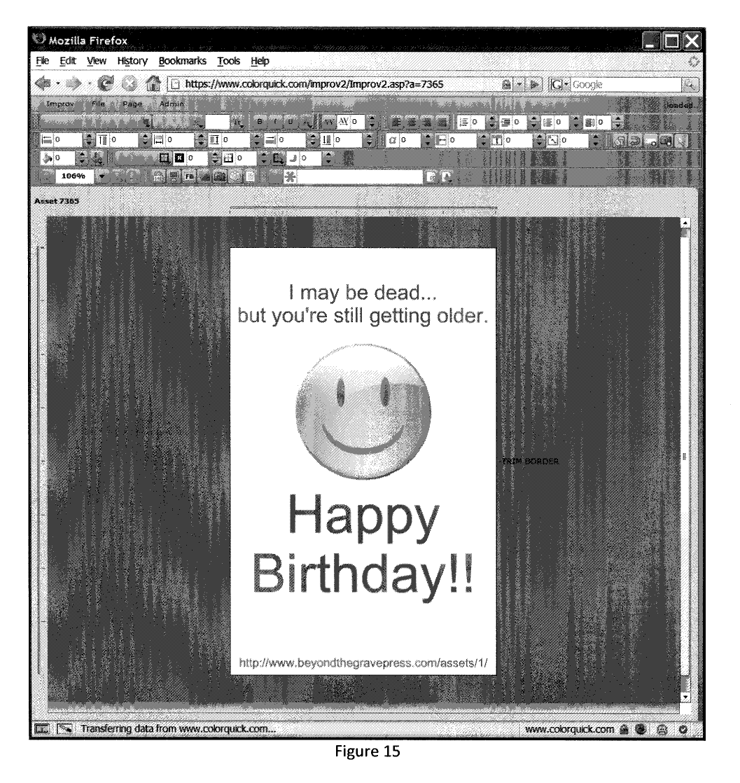

FIG. 15 shows how a user can create and customize cards to send.

The customer must agree to the terms of service to register with the service that delivers the messages and/or gifts. The terms of service preferably includes standard limits of liability clauses, as well as clauses that allow the service to make the messages available to law enforcement personnel upon receiving appropriate requests, and clauses that allow the service to cease sending periodic messages upon the request of a recipient.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An automated computer-implemented method of sending messages on behalf of dead persons to live recipients, the method comprising:
(a) receiving and storing message information in an administration computer from a plurality of live customers, the message information for each customer including:
(i) identity data of the customer,
(ii) identity data of one or more recipients who are to receive one or more messages from the customer after the customer dies,
(iii) message data to be sent to the one or more recipients, the message data being the one or more messages, and
(iv) message sending instructions including timing information regarding when to send the one or more messages after the customer dies;
(b) maintaining a life/death customer status file in the administration computer regarding the plurality of customers who previously stored message information in the administration computer;
(c) periodically updating the life/death customer status file by comparing its entries to a current decedent file; and
(d) sending the one or more messages previously stored by a customer to the one or more recipients in accordance with the stored message sending instructions when a customer is determined as having died in step (c).

2. The method of claim 1 wherein the one or more recipients in step (a)(ii) are initially live recipients, the method further comprising:
(e) maintaining a life/death recipient status file in the administration computer regarding the recipients who are to receive one or more messages from respective customers after the respective customers die;
(f) periodically updating the life/death recipient status file by comparing its entries to the current decedent file, wherein step (d) further comprises sending the one or more messages only to live recipients.

3. The method of claim 1 wherein the timing information designates one or more of the following situations:
(i) upon death of a customer,
(ii) upon the first occurrence of a date after the death of a customer,
(iii) upon the periodic occurrence of a date after the death of a customer, and
(iv) upon a predefined future date after the customer dies.

4. The method of claim 1 further comprising:
(e) editing the message information in step (a)(ii)-(iv) upon request by the customer after the message information is initially received and stored.

5. The method of claim 1 further comprising:
(e) receiving monetary payment from a customer before step (d) occurs.

6. The method of claim 1 wherein the one or more messages are sent by mail.

7. The method of claim 1 wherein the one or more messages include printed material.

8. The method of claim 1 wherein the one or more messages include links to audio/visual materials available via an electronic network.

9. The method of claim 1 wherein the identity data of the one or more recipients includes mailing address data, the method further comprising:
(e) validating the mailing address of the one or more recipients.

10. An automated computer-implemented apparatus for sending messages on behalf of dead persons to live recipients, the apparatus comprising:
(a) an administration computer that receives and stores message information from a plurality of live customers, the message information for each customer including:
(i) identity data of the customer,
(ii) identity data of one or more recipients who are to receive one or more messages from the customer after the customer dies,
(iii) message data to be sent to the one or more recipients, the message data being the one or more messages, and
(iv) message sending instructions including timing information regarding when to send the one or more messages after the customer dies;
(b) a life/death customer status file maintained in the administration computer regarding the plurality of customers who previously stored message information in the administration computer;
(c) means for periodically updating the life/death customer status file by comparing its entries to a current decedent file; and
(d) means for sending the one or more messages previously stored by a customer to the one or more recipients in accordance with the stored message sending instructions when a customer is determined as having died as a result of the comparison.

11. The apparatus of claim 10 wherein the one or more recipients in step (a)(ii) are initially live recipients, the apparatus further comprising:
(e) a life/death recipient status file maintained in the administration computer regarding the recipients who are to receive one or more messages from respective customers after the respective customers die;
(f) means for periodically updating the life/death recipient status file by comparing its entries to the current decedent file, wherein the means for sending sends the one or more messages only to live recipients.

12. The apparatus of claim 10 wherein the timing information designates one or more of the following situations:
(i) upon death of a customer,
(ii) upon the first occurrence of a date after the death of a customer,
(iii) upon the periodic occurrence of a date after the death of a customer, and
(iv) upon a predefined future date after the customer dies.

13. The apparatus of claim 10 further comprising:
(e) means for editing the message information in (a)(ii)-(iv) upon request by the customer after the message information is initially received and stored.

14. The apparatus of claim 10 further comprising:
(e) means for receiving monetary payment from a customer before any messages are sent.

15. The apparatus of claim 10 wherein the one or more messages are sent by mail.

16. The apparatus of claim 10 wherein the one or more messages include printed material.

17. The apparatus of claim 10 wherein the one or more messages include links to audio/visual materials available via an electronic network.

18. The apparatus of claim 10 wherein the identity data of the one or more recipients includes mailing address data, the apparatus further comprising:
(e) means for validating the mailing address of the one or more recipients.

19. An article of manufacture for sending messages on behalf of dead persons to live recipients, the article of manufacture comprising a computer-readable medium encoded with computer-executable instructions for performing a method comprising:
(a) receiving and storing message information in an administration computer from a plurality of live customers, the message information for each customer including:
(i) identity data of the customer,
(ii) identity data of one or more recipients who are to receive one or more messages from the customer after the customer dies,
(iii) message data to be sent to the one or more recipients, the message data being the one or more messages, and
(iv) message sending instructions including timing information regarding when to send the one or more messages after the customer dies;
(b) maintaining a life/death customer status file in the administration computer regarding the plurality of customers who previously stored message information in the administration computer;
(c) periodically updating the life/death customer status file by comparing its entries to a current decedent file; and
(d) sending the one or more messages previously stored by a customer to the one or more recipients in accordance with the stored message sending instructions when a customer is determined as having died in step (c).

20. The article of manufacture of claim 19 wherein the one or more recipients in step (a)(ii) are initially live recipients, and the computer-executable instructions perform a method further comprising:
(e) maintaining a life/death recipient status file in the administration computer regarding the recipients who are to receive one or more messages from respective customers after the respective customers die;
(f) periodically updating the life/death recipient status file by comparing its entries to the current decedent file, wherein step (d) further comprises sending the one or more messages only to live recipients.

21. The article of manufacture of claim 19 wherein the timing information designates one or more of the following situations:
(i) upon death of a customer,
(ii) upon the first occurrence of a date after the death of a customer,
(iii) upon the periodic occurrence of a date after the death of a customer, and
(iv) upon a predefined future date after the customer dies.

22. The article of manufacture of claim 19 wherein the computer-executable instructions perform a method further comprising:
(e) editing the message information in step (a)(ii)-(iv) upon request by the customer after the message information is initially received and stored.

23. The article of manufacture of claim 19 wherein the computer-executable instructions perform a method further comprising:
(e) receiving monetary payment from a customer before step (d) occurs.

24. The article of manufacture of claim 19 wherein the one or more messages are sent by mail.

25. The article of manufacture of claim 19 wherein the one or more messages include printed material.

26. The article of manufacture of claim 19 wherein the one or more messages include links to audio/visual materials available via an electronic network.

27. The article of manufacture of claim 19 wherein the identity data of the one or more recipients includes mailing address data, and the computer-executable instructions perform a method further comprising:
(e) validating the mailing address of the one or more recipients.

28. An automated computer-implemented method of sending gifts on behalf of dead persons to live recipients, the method comprising:
(a) receiving and storing gift information in an administration computer from a plurality of live customers, the gift information for each customer including:
(i) identity data of the customer,
(ii) identity data of one or more recipients who are to receive one or more gifts from the customer after the customer dies,
(iii) gift data regarding gifts to be sent to the one or more recipients, and
(iv) gift sending instructions including timing information regarding when to send the one or more gifts after the customer dies;
(b) maintaining a life/death customer status file in the administration computer regarding the plurality of customers who previously stored gift information in the administration computer;
(c) periodically updating the life/death customer status file by comparing its entries to a current decedent file; and
(d) sending the one or more gifts previously stored by a customer to the one or more recipients in accordance with the stored gift sending instructions when a customer is determined as having died in step (c).
